(19) United States
(12) Patent Application Publication
(10) Pub. No.: US 2010/0024241 A1
(43) Pub. Date: Feb. 4, 2010

(54) Drying apparatus

(76) Inventor: Don Cannetti, West Babylon, NY (US)

Correspondence Address: Thomas A. O'Rourke;Bodner & O'Rourke, Suite 108, 425 Broadhollow Road, Melville, NY, 11747, US

(21) Appl. No.: 12/220,903

(22) Filed: Jul. 29, 2008

(51) Int. Cl. F26B 19/00

(52) U.S. Cl. 34/229

(57) ABSTRACT

The present invention relates to a body drying apparatus that is wall mountable and easily removable. In addition, all of the elements that make the device functional are housed within a single unit with an electrical cord extending from the device for providing power. The internal elements are attached to an insert that is easily received by and removed from the housing for cleaning or replacing. The outlets of the device located on the housing have multiple novel configurations and designs to increase the effective drying capability of the device.

### BACKGROUND OF THE INVENTION

1. Field of the Invention

This invention relates to a drying apparatus, more specifically an apparatus for drying a person's body after bathing. Instead of using a towel to remove moisture, a body drying apparatus expels hot air onto its users. A body dryer generally has a motor that operates a fan. The fan is placed in front of a heating unit. As the heating unit heats the surrounding air, the fan propels the air through the invention. Openings are placed in the invention for the hot air to expel onto the user.

2. Description of the Prior Art

Without question, towel drying is by far the unequivocally popular method for drying off after a shower. Towels are simple, quick, and reusable. However, problems with towel drying still persist. It is very common for a user to have excess moisture still on the skin after using a towel. This excess moisture causes the user to feel as if he or she had never dried off in the first place. Multiple towel drying attempts rarely fix the problem. Usually the only solution is waiting to naturally air dry. Towels also present a problem with reusability. If the towel is stored in a damp or humid shower area or reused shortly after an initial use, the towel is usually damp making it ineffective in drying off the user. Towels can also develop mold if stored in a damp area. Moldy towels usually have a pungent unpleasing odor that is difficult to get rid of. In addition, towels are generally abrasive. When rubbed excessively against the skin, skin irritation and discomfort generally occurs.

The body blow dryer remedies many of the problems associated with towel drying. By discharging hot air on the user, moisture is removed by heating the moisture until it evaporates or by being blown off the body by the propelled air. Body blow dryers are a convenient and effective alternative to towel drying. Body blow driers remove the excess moisture that towels leave behind faster than air drying. Also, body blow driers can be used multiple times with a short duration between uses. In addition, body blow dryers never develop mold thus never develop any pungent odors. Lastly, body blowers do not irritate the skin due to excessive rubbing.

It is known in the art, from U.S. Pat. No. 3,128,161, to have a system that heats and expels air for the purposes of drying a person. This conventional system usually has a fan with a heating element. When the heating element is activated, the air surrounding the heating element is heated. When the fan is activated, the heated air is blown through the device. In the conventional system, a grate is located at the opposite end of the fan, the heated air exits through the grate when the fan is activated and blows onto the user for the purposes of drying. The problem with the conventional design is the failure to uniformly dry the user's body. In the conventional system, only a grate located at one end of the device expels hot air. This means only a small surface area of the body is exposed to the hot air.

Further improvements to the body dryer, such as in U.S. Pat. No. 4,780,595, have been made to more uniformly dry the body. The body dryer, instead of having a grate where the hot air is expelled, has a vent that extends upward along a vertical housing. This allows hot air to escape at different points as it travels up or down the device. While this design improves on the uniformity problem of earlier body dryers, it still fails to completely dry the user uniformly. The device rests on the ground with the fan and heating unit residing at one end of the device. While the air is propelled through the device, it gradually cools and loses speed. As the distance increases, the air becomes cooler and slows to a point where it is ineffective in drying the user. This means that if the fan is placed at the floor of the device, hot air must travel from the floor to the head of a user which is around 5′ to 6′ above the ground, a considerable distance.

Further improvement to the body dryer, as seen in U.S. Pat. No. 6,131,303, occurred when the device was elevated off of the ground and mounted on a wall. The wall mounted body dryer still maintained the vertical housing so that vents could be placed vertically along the device to more uniformly blow dry the user. With this design, hot air wouldn't have to travel as far before reaching the user. Usually, wall mounted designs are fixed to the wall or ceiling with a motor being placed either inside of the wall or in another room to save space. The problem with this wall mounted design has been the loss of portability and an increase expense of attaching the device to the wall and running piping through the wall.

When operating a body dryer or any device with a fan, a common occurrence is the buildup of dust and lint in the device. This may lead to decreased air flow or overheating of the device. Conventional body dryers may use filters to prevent dust buildup, but over time the device and filter needs to be cleaned. This generally proves to be an arduous task, since conventional dryers are complicated pieces of machinery consisting of many complex parts.

Even more problems arise to prevent cleaning the device when the device is partially built into a wall. While the complexity of the body dryer makes it difficult to clean, it also makes it difficult to replace parts in the device. Usually the entire device must be brought into a repair shop and disassembled. This is an expensive process. If the device is attached to a wall or pieces of the device reside within a wall, the device cannot even be brought into a repair shop. In this situation, a repairman must be called to the site of the body dryer to perform the cleaning. This process costs even more than bringing the device into the shop since it requires a repairman to travel to the site and fix the body dryer on site.

Noting the problems addressed herein, the body dryer according to the present invention substantially improves the conventional wall mount device by creating a one piece design that mounts on a wall for improved portability, decreased cost and simplified design and installation. The body dryer according to the present invention also substantially improves the ability to clean and fix the device by having a removable insert that slides in and out of the housing providing easy access to the internal elements of the device.

### OBJECTS OF THE INVENTION

It is an object of an invention to enclose all elements of the body blower dryer in a single housing.

It is an object of the invention to uniformly dry a user when operated.

It is an object of the invention to dry a user when operated in a smaller amount of time than previous inventions.

It is an object of the invention to mount on a wall.

It is an object of the invention to be detachable from a wall.

It is an object of the invention to be held while using the invention.

It is an object of the invention to increase the effective drying area of the device by diverting the direction of the air flowing from the device.

It is an object of the invention to temperature control the air that is expelled.

It is an object of the invention to control the amount of air flowing from the device.

It is an object of the invention to control the rotational speed of the automated air diverters.

It is an object of the invention to control the amount of time that the device is activated.

It is an object of the invention to provide easy access to the internal elements for cleaning and repairing the device.

### SUMMARY OF THE INVENTION

The present invention effectively achieves the objectives cited and remedies many of the problems associated with the prior art. The present invention substantially improves upon the prior art by operating as a single-piece body dryer that is wall mountable. Alternative embodiments of the device increase the effective drying area using different configurations for the air diverters. Examples of such embodiments may be rotating or adjustable air diverters, multiple tubes extending from a single housing. Alternative embodiments also decrease the time required to dry the body by controlling the temperature and speed of the air that is expelled from the device. In addition, the present invention might have a timing device for automatic shutoff to prevent unintended extended use of the device if placed in a public rest room or locker room.

The present invention differentiates itself from the prior art by operating as a wall mountable single housing unit. The unit comprises a housing having a vent at one end and a series of orifices known as air diverters placed along the side of the housing. The vent permits air to pass into the device so that the air can be subsequently expelled from the device after being heated, through the air diverters. Air is propelled through the device using a fan and motor, both of which reside inside an insert that is placed inside the housing. The fan is attached to the motor by a shaft that extends from the motor and attaches to the fan. A heating element is placed inside the housing to heat the air before it is expelled through the air diverters by the fan. An electric cord to power the motor that operates the fan and heating element extends from the insert and plugs into a power outlet. One or more filters may be placed at the inlet or at the air diverters to capture dust.

In addition to operating as a single unit, the present invention is also wall mountable. Being as the device is only a single piece, all of which is accessible to the user, the device is easily carried from one place to the next. This permits multiple users to use the device in multiple rooms saving the users from having to purchase two or more body dryers in order to have access to them. In an alternative embodiment, the device may also be handheld so that users can hold the device while in use to dry certain areas more thoroughly than others. The device contains metal brackets on the housing so that the device can be attached to a wall or ceiling. The use of metal brackets permits the device to be removed or reattached easily from the wall. An electric plug connects to an electric outlet to operate the motor, fan and heating element. The plug is generally a 120V cord that fits into a 120 V Ground Fault Interrupter (“GFI”) outlet. The plug is generally fit for a GFI outlet because the outlet is specifically designed to prevent against electric shock. Electric shock could occur if the user touches the device while it is operating. Since one of the intended uses of the device is for the user to operate it as a handheld, the probability of electric shock increases because the user is wet while operating the device.

The present invention increases the drying effectiveness over conventional body dryers. The preferred embodiment is a tube containing a series of holes known as air diverters. It is possible to imagine other arrangements of the air diverters in the present design, such as staggering or grouping the air diverters. By staggering the air diverters, the effective horizontal drying area increases. An increase in horizontal drying area will require less movement by users to dry the front and back of their bodies. Grouping the air diverters may aid in helping the users dry portions of the body that are hard to reach, such as the lower back. A group of air diverters may be positioned to provide more hot air to a user's lower back to speed up the drying process.

It is also possible to imagine other configurations for the air diverters. For example, the air diverters could be slitted or slotted orifices. With slitted or slotted orifices, the air exiting the device may be shaped into a thin sheet. The thin sheet of air acts as a squeegee on the user's body, wiping off the excess moisture as the user moves relative to the device. This type of design may be more efficient for drying limits such as hands and feet since limbs are easier to contort and adjust to the thin sheet of air.

The user may reposition the air diverters to control where the air is directed. This allows for maximum coverage by the device while in use and allows the user to position the air diverters based on personal preference. In one embodiment, the air diverters may be attached to the device using a ball and joint design. One end of the diverter may have outlets and protrude out of the device. The other end of the device may have a spherical or ball shape with inlets. The spherical end may be received by a joint located in the housing. The joint secures the air diverter into the housing. The user may grab the protruding portion of the air diverter and readjust the diverter while it is still secured in the housing.

In alternative embodiments, the device may contain vent covers to close certain holes. By closing one or more holes, the same amount of air propelled from the fan must exit through fewer holes thus increasing the amount of air exiting each of the other holes. The vents may also be louvered directional vents. With louvered directional vents, a series of slats cover the vent instead of one piece. The slats that help close certain holes may be adjustable. When the slats are adjusted perpendicular to the vent opening, air escapes straight out of the device. When the slats are adjusted parallel to the vent opening, air cannot escape the device. Slats may also be adjusted to different angles. At different angles, the slats direct air in different directions. Users may adjust the slats to customize the body blower.

The device may also have rotating nozzles that constantly move. Nozzles may move back and forth along a horizontal axis or may move in a circular motion. The change of direction generally allows the device to increase its effective area while still maintaining uniform drying capabilities. The automated air diverters may significantly decrease the amount of movement required by a user while using the device. A speed control may be added to the device to control the speed at which the nozzles rotate.

The present device's vertical housing is tube-shaped having a portion of the housing with a smaller cross section. The portion of the housing with a smaller cross section has the air diverters while the portion of the housing with the larger cross section is where the motor, fan and heating element are located. In alternative embodiments, the device's housing may also have a tube shape that is tapered with a wider cross section located closest to the fan and a smaller cross section located at the farthest point from the fan. As the air travels through the device, and more specifically, farther from the fan, it loses velocity. This tapered design compensates from the loss in air velocity by concentrating the air into a smaller area before expelling it from the device.

The insert is similarly shaped like the housing but is sized slightly smaller in cross section than the housing. The housing receives the insert through the orifice on the top of the wider portion of the housing. The insert's tapered portion contacts the housing's tapered portion and is secured to the housing by screwing the cover of the housing onto the shaft of the insert.

The present invention may have a rotatable or pivot able section to reposition the air holes while in use. By pivoting or rotating the portion of the device containing the air holes, the user can adjust the holes to dry a certain area more effectively than in the original configuration. Also, the user can pivot and rotate the invention to have the air holes point downward. When the device is on, air will spray downward. The user will be able to dry his or her hair using the body dryer. The tubular portion containing the air holes may also be in different shapes or sizes. For example, one possible shape would be circular. Thus, if a user pivoted the invention to spray air downward, the invention would cover a circular surface area, which is more conducive to drying a head of hair.

The present invention may contain controls to regulate the air expelled from the device. The present invention may have controls to regulate the temperature or flow of the air. The present invention may also have controls to regulate the time that the device is active. Although the current disclosure lists some of the many controls possible for the current invention, it is possible to imagine other controls for the present design. The temperature control may regulate the temperature of the heating element. The surrounding air is heated relative to the temperature of the heating element. This heated air is then propelled through the device by the fan, expelled through the air diverters and onto the user. The flow control may regulate the speed at which the surrounding air is expelled from the device by controlling the fan's speed. A timing control may regulate the amount of time that the device is active. This control is useful in public settings where the ability to automatically shut off could prevent the device from wasteful use or possible operation while no one is using the device.

### BRIEF DESCRIPTION OF THE DRAWINGS

FIG. 1 is a front view of the present invention.

FIG. 2 is a side view of the present invention.

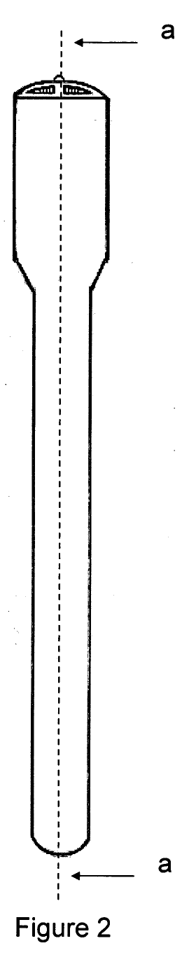

FIG. 3 is a sectional view along the line a-a in FIG. 2.

FIG. 4 is a rear view of the present invention.

### DETAILED DESCRIPTION OF THE INVENTION

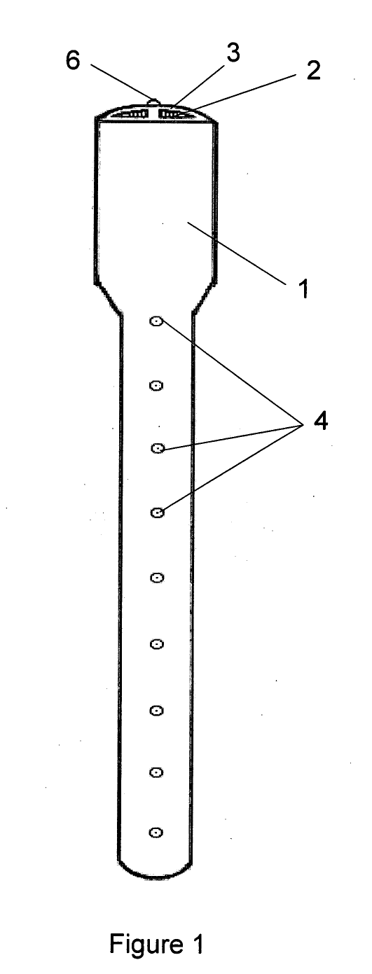

FIG. 1 is a front view of the body blower dryer as it would be viewed during operation. The body blower dryer is a single unit with a vertical enclosure or housing 1 that receives an insert 14. The insert 14 protects the internal elements of the device. The housing 1 is generally a cylindrically shaped side wall with a first end and a second end. The first end has a wider cross section than the second end with a tapered portion connecting the two ends. The edge of the sidewall at the second end has a bottom surface. The bottom surface is semi-spherical however it may be a flat surface. Generally the first end with a wider cross section receives an insert 14 that holds the motor 7, fan 9 and heating element 10 while the second end contains a plurality of air diverters 4 for air to escape from the device. The wider end has an orifice. This orifice provides access to the insert for either installation, cleaning or repair. It also allows air to flow into the device so that the air can be heated and expelled through the air diverters 4. A cover 6 is placed over the orifice. The cover 6 is vented by having a plurality of orifices in its top surface arranged in pattern that allows maximum air flow while also preventing other objects from entering the housing. The vent 2 permits air to pass into the device, while at the same time, prevent other objects from entering. The cover 6 in the figure is shown as having a semi-spherical shape. It is possible to imagine other configurations for the cover. A cap screw 3 locks the cover 6 into place so that it stays intact with the housing 1. The cover has an orifice in the center for receiving a screw. The cover 6 is attached to the insert 14 by screwing a screw through the cover and into the shaft 8.

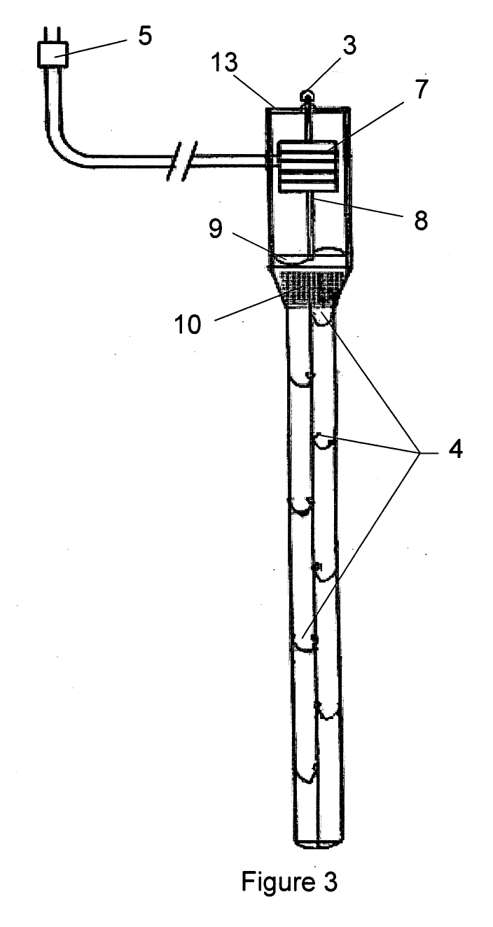

FIG. 3 is a sectional view of the device that depicts the internal elements as they reside in the insert 14. The insert 14 is shaped similar to the housing 1; however, the cross sections of each portion of the insert are generally smaller so that the housing can receive the insert. The insert 14 generally has a cylindrically shaped side wall with a first end and a second end. The first end has a wider cross section than the second end with a tapered portion connecting the two ends. The edge of the sidewall at the second end has a bottom surface. The bottom surface is semi-spherical however it may be a flat surface. The wider end has an orifice. The shaft 8 extends out of the orifice so that the cover 6 may be attached to the shaft 8 locking the insert 14 into place within the housing 1. The insert's 13 sidewall, has a cross section that is smaller than the cross section of the housing. The smaller cross section allows the housing 1 to receive the insert 14 through the orifice in the top of the wider portion of the housing 1.

The internal elements generally comprise a motor 7, heating element 10, fan 9 and shaft 8. The motor 7 and heating element 10 are powered by the outlet while a shaft 8 connects the motor 7 to a fan propeller 8. The preferred arrangement of the internal elements inside the housing 1 is to have the motor 7 located closest to the vent 2 followed by the shaft 8 connecting the fan propeller 9 to the motor 7. The heating element 10 is then placed adjacent to the fan 9. However, it's possible to imagine alternative arrangements of the internal elements of the device.

While the device in operation, the motor 7 rotates the shaft 8. The shaft 8 connects to the fan propeller 9 causing the propeller 9 to also rotate. While the propeller 9 is rotating, air is drawn into the device through the vent 2 located on the cover 6 of the device. The air travels through the wide portion of the housing 1 and passes the motor 7 and shaft 8 before reaching the fan propeller 9. A heating element 10 located near the fan heats the air before the air travels down the thinner portion of the housing 1 and exiting through the air diverters 4.

The heating element 10 depicted is a cross threading of metal wiring. When electricity is supplied to the heating element 10, the wires begin to heat. The temperature of the surrounding air is increased because the air touching the wires absorbs this heat. While only the preferred embodiment of the heating element is depicted, it is possible to imagine other configurations of the present design.

A power cord 5 extends from the insert 14. An orifice is generally placed in the side wall of the wider portion of the housing 1. The orifice is sized large enough to fit a power cord 5. The cord 5 is generally a 120V cord 5 that fits into a 120 V Ground Fault Interrupter (“GFI”) outlet. Electric shock could occur if the user touches the device while it is operating. Since one of the intended uses of the device is for the user to operate it as a handheld, the probability of electric shock increases because the user is wet while operating the device. The plug is generally fit for a GFI outlet because the outlet is specifically designed to prevent against electric shock.

FIG. 1 depicts the preferred embodiment of the invention as a series of air diverters 4 arranged in a row along the thin portion of the housing 1. FIG. 3 depicts an alternative arrangement of air diverters 4. While only two arrangements are shown, it is possible to imagine other configurations of the present design.

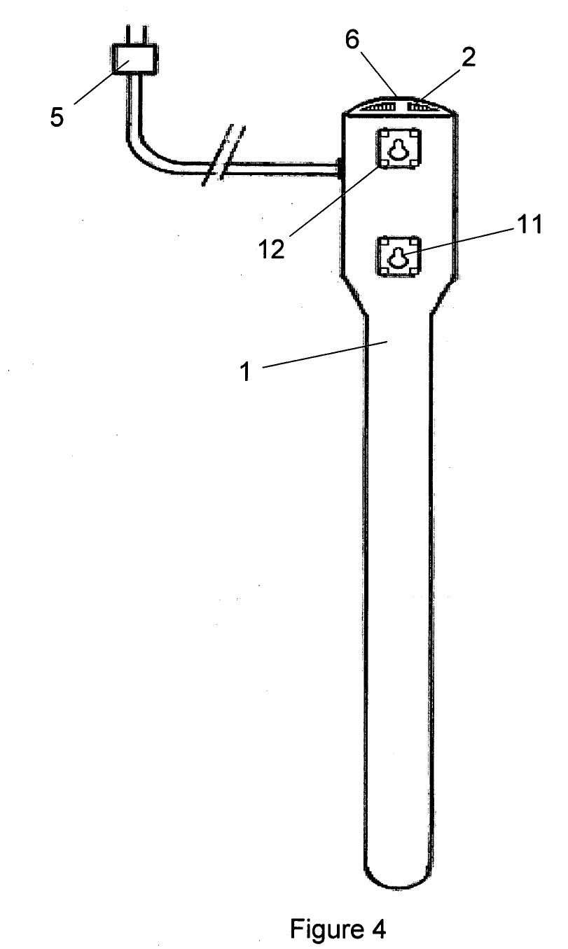

FIG. 4 shows the rear view of the device. The vent 2 on the cover 6 is visible from the back as well. The vent 2 incorporates a substantial portion of the device's cover 6 allowing more air to flow into the device while the device is operating.

In addition to operating as a single unit, the present invention is also wall mountable. The device has metal brackets 11 attached to the housing 1 using screws. Screw holes 12 are provided on the brackets 11 and the housing 1 so that the brackets are secured. The use of metal brackets 11 permits the device to be removed or reattached with minimal effort. Being as the device is only a single piece the device is may be easily carried from one place to the next. This permits one or more users to use a single device in one or more rooms saving the user or users from having to purchase two or more body dryers in order to have access to them in multiple locations.

Although no air diverters 4 are depicted on the back of the device in FIG. 4, one possible embodiment may have air diverters 4 located on the back. This is because, in an alternative embodiment, the device may be handheld so that users can hold the device while in use to manipulate the positioning of the device. This will allow the user to dry certain areas more thoroughly than others.

I claim:

1. A body blow dryer for applying heated air to a user comprising a housing that is securable to a wall surface, said housing comprising a first section and a second section, said first section having an opening for receiving an inflow of air and said air being drawn into said housing by a fan in said first section, said fan being powered by a motor in said first section, said first section being joined to said second section by a transition portion, said transition portion having a heating element therein for heating the air flowing from said first section to said second section, said second section being in the form of a hollow tubular member said second section having a plurality of air diverters for diverting heated air onto a user.

2. The body blow dryer according to claim 1 wherein the air diverters are adjustable.

3. The body blow dryer according to claim 2 wherein said first section has a vented top surface for receiving air.

4. The body blow dryer according to claim 3 wherein said first section has a top surface and one or more side surfaces extending from said top surface, said first section having a transition portion extending from an end of said first section opposite said top surface, said transition portion having a first end and a second end, said first end being secured to said first section, said second end being secured to said second section, said second section having at least one sidewall.

5. The body blow dryer according to claim 4 wherein said transition portion is generally conical in shape.

6. The body blow dryer according to claim 5 wherein said second section has a first end secured to said transition portion and a second end secured to said side wall at an end thereof.

7. A body blow dryer for applying heated air to a user comprising
a housing that is securable to a wall surface, said housing comprising a first section and a second section, said first section being in the form of a hollow tubular member, said first section having an opening for receiving an insert, said first section being joined to said second section by a transition portion, said second section being in the form of a hollow tubular member said second section having a plurality of air diverters for diverting heated air onto a user;
an insert that is receivable by said housing, said insert comprising a first section and a second section, said first section having an opening for receiving an inflow of air and said air being drawn into said housing by a fan in said first section, said fan being powered by a motor in said first section, said first section being joined to said second section by a transition portion, said transition portion having a heating element therein for heating the air flowing from said first section to said second section, said second section being in the form of a hollow tubular member said second section having a plurality of orifices for diverting heated air through the air diverters of said second section of said housing onto a user.

8. The body blow dryer according to claim 7 wherein the air diverters are adjustable.

9. The body blow dryer according to claim 8 wherein said first section has a vented top surface for receiving air.

10. The body blow dryer according to claim 9 wherein said first section has a top surface and one or more side surfaces extending from said top surface, said first section having a transition portion extending from an end of said first section opposite said top surface, said transition portion having a first end and a second end, said first end being secured to said first section, said second end being secured to said second section, said second section having at least one sidewall.

11. The body blow dryer according to claim 10 wherein said transition portion is generally conical in shape.

12. The body blow dryer according to claim 11 wherein said second section has a first end secured to said transition portion and a second end secured to said side wall at an end thereof.
